(19) United States
(12) Patent Application Publication
(10) Pub. No.: US 2025/0123848 A1
(43) Pub. Date: Apr. 17, 2025

(54) INTER-PROCESSOR COMMUNICATIONS

(71) Applicant: Intel Corporation, Santa Clara, CA (US)

(72) Inventors: Yi-Feng LIU, Chandler, AZ (US); Eric J. DEHAEMER, Shrewsbury, MA (US); Eswaramoorthi NALLUSAMY, Cedar Park, TX (US)

(21) Appl. No.: 18/634,236

(22) Filed: Apr. 12, 2024

(51) Int. Cl. G06F 9/4401; G06F 9/54

(52) U.S. Cl. CPC G06F 9/4403; G06F 9/544

(57) ABSTRACT

Examples described herein relate to partitioning of processor sockets. A first processor socket includes first communication circuitry associated with a first partition identifier and a second processor socket includes a second communication circuitry associated with a second partition identifier. In some examples, based on a boot operation associated with the first processor socket: the first communication circuitry is to permit communication with the second communication circuitry based on a first partition identifier matching the second partition identifier and the first communication circuitry is to disable communication with the second communication circuitry based on the first partition identifier not matching the second partition identifier.

### BACKGROUND

A server can include multiple processor sockets that communicate with each other to increase available processor and cache and memory resources. For example, by communication among multiple processor sockets, available cache size and memory resources can increase. For example, Intel® Xeon processor sockets can be connected in various configurations, such as 1 socket (1S), 2 socket (2S), 4 socket (4S), 8 socket (8S), or above 8S configurations.

### BRIEF DESCRIPTION OF THE DRAWINGS

FIG. 1 depicts an example system.

FIG. 2 depicts an example system.

FIG. 3 depicts of socket partitioning.

FIG. 4 depicts an example process.

FIG. 5 depicts an example system.

### DETAILED DESCRIPTION

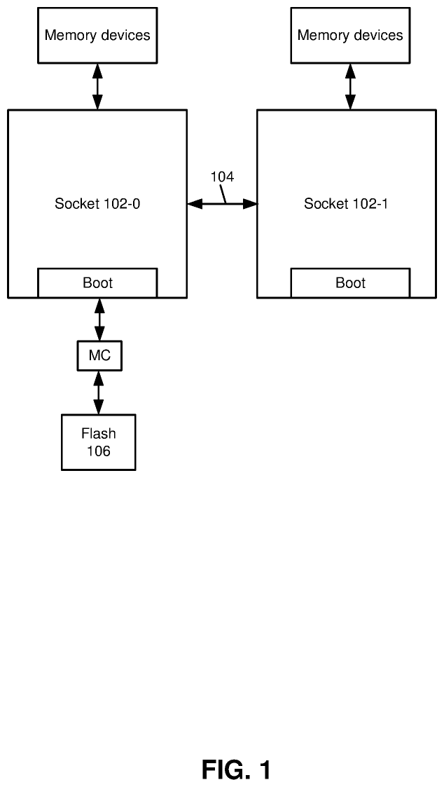

Cloud Service Providers (CSPs) and High Performance Computing (HPC) applications can utilize flexible socket partitioning to create isolated zones to dynamically operate a server in an 8 socket (8S) system setup with two isolated 4S zones (2×4S) or 4×2S, or other configurations, based on total cost of ownership (TCO), workload shuffling, or data center orchestrator planning. FIG. 1 depicts an example system with a 2 socket (2S) zone. Processor sockets 102-0 to 102-1 can communicate using a socket interconnect 104. Multi-socket topologies can utilize custom configurations with a custom boot sequence and socket interconnections based on topology. A legacy (boot) socket 102-0 can provide boot operations for one or more non-legacy sockets (e.g., socket 102-1). For example, legacy socket 102-0 boots firmware from flash 106 and secondary socket 102-1 accesses firmware from flash 106 through memory controller (MC) of primary socket 102-0. However, when socket 102-0 becomes inactive or inoperative, connected socket 102-1 may become inoperative and a system reboot may occur. Moreover, other zones may also become inoperative. CSPs and HPC can experience a service disruption from a system reboot, which can impact revenue and quality of service (QOS) offered to tenants.

Where sockets are partitioned into zones, various examples provide for isolation among processor sockets in different zones based on platform identifier (ID) (PID) per zone. During link training with a target processor socket over a socket interconnect, circuitry and/or platform firmware of an initiator processor socket can read or receive a PID value of the target processor socket. If the target processor socket is in a same partition (zone) as that of the initiator processor socket, the initiator processor socket can perform multi-socket boot flow with this target processor socket. If the initiator processor socket is not in the same partition (zone) as the target processor socket, the initiator processor socket can disable the associated socket interconnect and cease further communication with the target processor socket to isolate from the target processor socket.

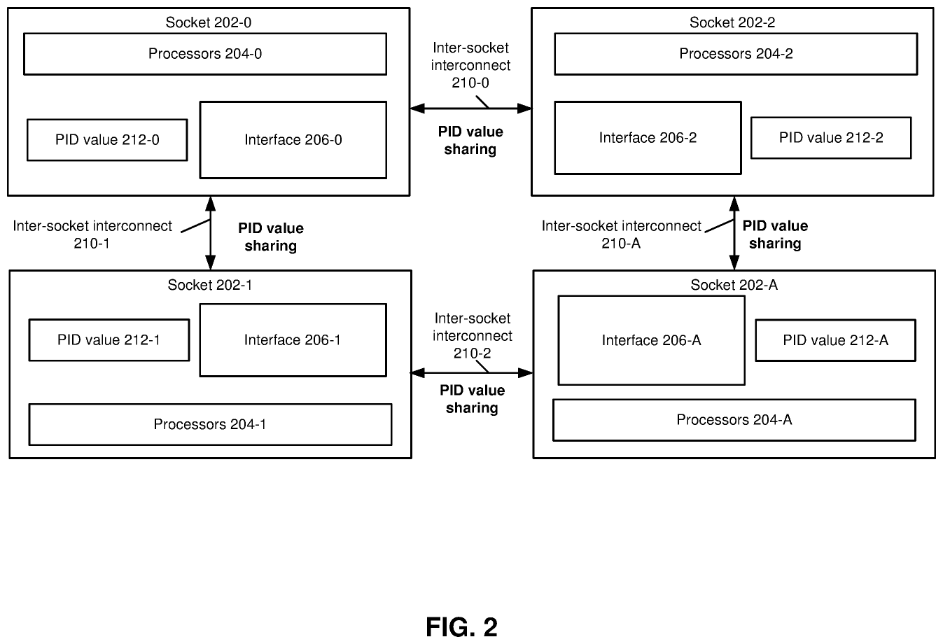

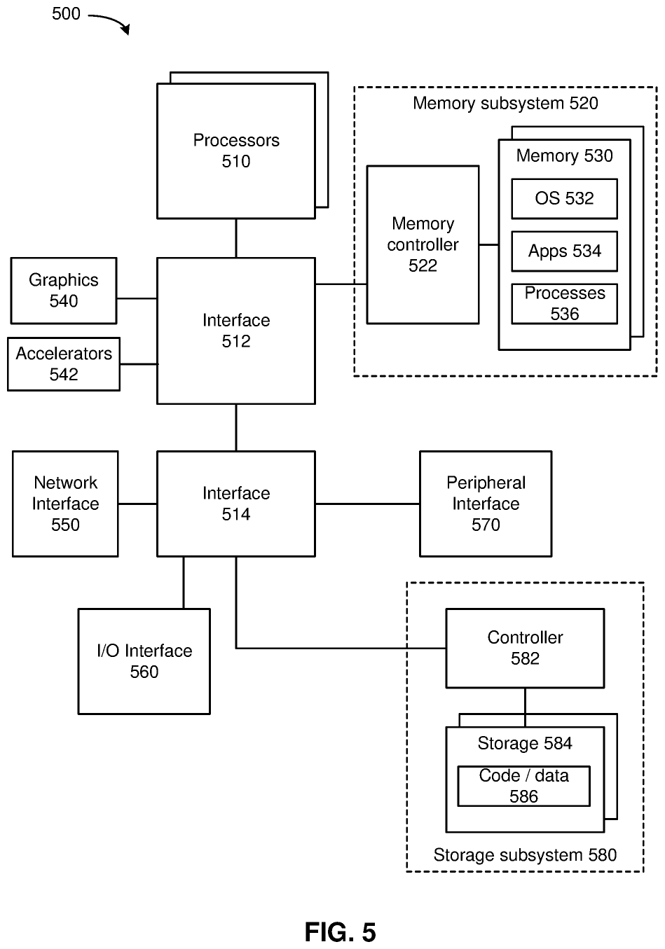

FIG. 2 depicts an example system. Sockets 202-0 to 202-A, where A is an integer, can include associated processors 204-0 to 204-A and interfaces 206-0 to 206-A as well as silicon firmware and other software or circuitry described at least with respect to FIG. 5. One or more of sockets 202-0 to 202-A can include a cover that is made of plastic and can include metal contacts for pins or lands of a processor (e.g., a central processing unit (CPU) core, graphics processing unit (GPU), field programmable gate array (FPGA), application specific integrated circuit (ASIC), or other circuitry). Processors with a pin grid array (PGA) or land grid array (LGA) package can be inserted into a socket.

In some examples, one or more of sockets 202-0 to 202-A can include a physical package that includes one or more discrete dies or tiles connected by mesh or other connectivity as well as an interface (not shown) and heat dispersion (not shown). A die can include semiconductor devices that include one or more processing devices or other circuitry. A tile can include semiconductor devices that include one or more processing devices or other circuitry. For example, a physical package can include one or more dies, plastic or ceramic housing for the dies, and conductive contacts conductively coupled to a circuit board.

A processor core can include an execution core or computational engine that is capable of executing instructions. A core can access to its own cache and read only memory (ROM), or multiple cores can share a cache or ROM. Cores can be homogeneous (e.g., same processing capabilities) and/or heterogeneous devices (e.g., different processing capabilities). Frequency or power use of a core can be adjustable. A core can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

Any type of inter-processor communication techniques can be used, such as but not limited to messaging, inter-processor interrupts (IPI), inter-processor communications, and so forth. Cores can be connected in any type of manner, such as but not limited to, bus, ring, or mesh. Cores may be coupled via an interconnect to a system agent (uncore).

A system agent can include a shared cache which may include any type of cache (e.g., level 1, level 2, or last level cache (LLC)). A system agent can include or more of: a memory controller, a shared cache, a cache coherency manager, arithmetic logic units, floating point units, core or processor interconnects, or bus or link controllers. A system agent or uncore can provide one or more of: direct memory access (DMA) engine connection, non-cached coherent master connection, data cache coherency between cores and arbitrate cache requests, or Advanced Microcontroller Bus Architecture (AMBA) capabilities. System agent or uncore can manage priorities and clock speeds for receive and transmit fabrics and memory controllers.

PID values 212-0 to 212-A can store associated PID values assigned to respective sockets 202-0 to 202-A. An associated PID value can identify socket partitioning assignment. For example, PID values 212-0 to 212-A can store PID values in one or more of: fuses, register, pins, bitmap).

Sockets 202-0 to 202-A can utilize associated interfaces 206-0 to 206-A to communicate with another socket using one or more of socket interconnects 210-0 to 210-A. For example, interfaces 206-0 to 206-A can include physical layer interface (PHY) circuitry to communicate via another interface among interfaces 206-0 to 206-A. As described herein, interfaces 206-0 to 206-A can share a PID value with a neighboring socket in a same zone.

Two or more of sockets 202-0 to 202-A can be conductively connected together using socket interconnects 210-0 to 210-A. For example, socket interconnect 210-0 can provide communication among sockets 202-0 and 202-2, socket interconnect 210-1 can provide communication among sockets 202-0 and 202-1, socket interconnect 210-2 can provide communication among sockets 202-1 and 202-A, and socket interconnect 210-A can provide communication among sockets 202-2 and 202-A.

In some examples, interfaces 206-0 to 206-A and socket interconnects 210-0 to 210-A can operate in a manner consistent at least with Infinity Fabric from Advanced Micro Devices, Inc. (AMD), AMD HyperTransport, NVIDIA® NVLink, Intel® QuickPath Interconnect (QPI), Advanced Microcontroller Bus Architecture (AMBA), Coherent Hub Interface (CHI) Chip to Chip (C2C), TileLink, RISC-V processor interconnect, Intel® Ultra Path Interconnect (UPI), Intel® On-Chip System Fabric (IOSF), Omnipath, Compute Express Link (CXL) (see, for example, Compute Express Link Specification revision 2.0, version 0.7 (2019), as well as earlier versions, later versions, and variations thereof), Peripheral Component Interconnect express (PCIe) (see, for example, Peripheral Component Interconnect (PCI) Express Base Specification 1.0 (2002), as well as earlier versions, later versions, and variations thereof), or other public or proprietary standards.

An example of operation can be as follows. In some examples, a customer (data center administrator or orchestrator) can determine a number of socket zones to provision. For example, a graphical user interface (GUI) or command line interface can present an option to enter a number of socket partitions and indicate which socket to associate with a particular partition identifier value. A circuitry (e.g., Complex Programmable Logic Device (CPLD)) can assign a PID (partition value) to a socket to be stored in PID values 212-0 to 212-A. A CPLD can provide various inputs, such as wake signals, power state control (Sx) signals, power button signals, etc.

For example, PID input value of 00 identifies partition 0; PID input value of 01 identifies partition 1; PID input value of 10 identifies partition 2; and PID input value of 11 identifies partition 3. At boot or during a parameter exchange during link training of an inter-socket connection, silicon firmware (e.g., boot firmware code and/or power management code executed by a power management unit) of an initiator socket (e.g., socket 202-0) can read PID values from sockets 202-1 and 202-2 to determine the assigned PID values. Similar operations can occur for socket 202-1 with sockets 202-0 and 202-A; for socket 202-2 with sockets 202-0 and 202-A; and for socket 202-A with sockets 202-1 and 202-2.

A socket can detect whether a link partner is in a different partition based on the socket's PID value being different. Based on sockets having a same PID value, PHYs of sockets with a same PID can communicate using an inter-socket interconnect. Sockets in a same partition, including software (e.g., operating system (OS) or processes) can share resources such as connected memory, cores in different sockets, cache, connected input/output (I/O), device interface-connected devices (e.g., PCIe, CXL) and other circuitry, firmware, or software. Sockets in a same partition can access memory in a coherent manner so that memory is shared.

Based on socket PID values being different, a PHY of one or both sockets can be disabled by firmware and/or microcontroller-executed software to not communicate with a PHY of a socket with a different PID value. In some examples, sockets connected by a socket interconnect can read partition identifier values and both determine whether to permit or disable communications over the socket interconnect. In some examples, a first socket connected by a socket interconnect to a second socket interconnect can read a partition identifier value and both determine whether to permit or disable communications over the socket interconnect with the second socket but the second socket does not determine permit or disable communications over the socket interconnect with the first socket.

In some examples, virtualization technologies can be used to partition peripheral devices to share access to virtualized peripheral devices among sockets. Peripheral devices can include one or more of: a network interface device, memory device, storage device, accelerator, or other circuitry. Various examples of virtualization technologies include Single Root I/O Virtualization (SR-IOV) and Intel® Scalable I/O Virtualization (SIOV). Single Root I/O Virtualization (SR-IOV) and Sharing specification, version 1.1, published Jan. 20, 2010 specifies hardware-assisted performance input/output (I/O) virtualization and sharing of devices. Intel® Scalable I/O Virtualization (SIOV) permits configuration of a device to group its resources into multiple isolated Assignable Device Interfaces (ADIs). Direct Memory Access (DMA) transfers from/to an ADI are tagged with a unique Process Address Space identifier (PASID) number. Unlike the device partitioning approach of SR-IOV to create multiple virtual functions (VFs) on a physical function (PF), SIOV enables software to flexibly compose virtual devices utilizing the hardware-assists for device sharing at finer granularity. An example technical specification for SIOV is Intel® Scalable I/O Virtualization Technical Specification, revision 1.0, June 2018, as well as earlier versions, later versions, and variations thereof.

In some examples, boot firmware code or firmware can include one or more of: Basic Input/Output System (BIOS), Universal Extensible Firmware Interface (UEFI), or a boot loader. The BIOS firmware can be pre-installed on a personal computer's system board or accessible through an SPI interface from a boot storage (e.g., flash memory). In some examples, firmware can include SPS. In some examples, a Universal Extensible Firmware Interface (UEFI) can be used instead or in addition to a BIOS for booting or restarting cores or processors. UEFI is a specification that defines a software interface between an operating system and platform firmware. UEFI can read from entries from disk partitions by not just booting from a disk or storage but booting from a specific boot loader in a specific location on a specific disk or storage. UEFI can support remote diagnostics and repair of computers, even with no operating system installed. A boot loader can be written for UEFI and can be instructions that a boot code firmware can execute and the boot loader is to boot the operating system(s). A UEFI bootloader can be a bootloader capable of reading from a UEFI type firmware.

A UEFI capsule is a manner of encapsulating a binary image for firmware code updates. But in some examples, the UEFI capsule is used to update a runtime component of the firmware code. The UEFI capsule can include updatable binary images with relocatable Portable Executable (PE) file format for executable or dynamic linked library (dll) files based on COFF (Common Object File Format). For example, the UEFI capsule can include executable (*.exe) files. This UEFI capsule can be deployed to a target platform as an SMM image via existing OS specific techniques (e.g., Windows Update for Azure, or LVFS for Linux).

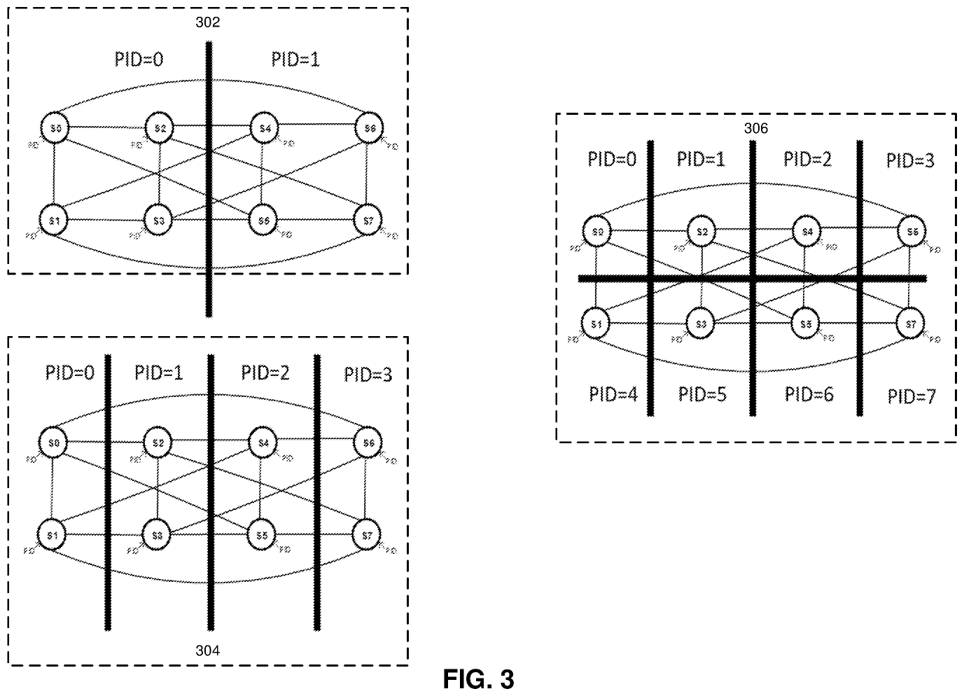

FIG. 3 depicts an example of socket partitioning. In configuration 302, a PID value of 0 can be assigned to four sockets (e.g., S0 to S3) whereas a PID value of 1 can be assigned to four other sockets (e.g., S4 to S7). After parameter exchange of PID values, one or more of sockets S0 to S3 can communicate with one or more sockets among sockets S0 to S3 by an inter-socket interface. After parameter exchange of PID values, one or more of sockets S4 to S7 can communicate with one or more sockets among sockets S4 to S7 by an inter-socket interface.

In configuration 304, a PID value of 0 can be assigned to two sockets (e.g., S0 to S1), a PID value of 1 can be assigned to two other sockets (e.g., S2 to S3), a PID value of 2 can be assigned to two other sockets (e.g., S4 to S5), and a PID value of 3 can be assigned to two other sockets (e.g., S6 to S7). After parameter exchange of PID values, one or more of sockets S0 to S1 can communicate with one or more sockets among sockets S0 to S1 by an inter-socket interface. After parameter exchange of PID values, one or more of sockets S2 to S3 can communicate with one or more sockets among sockets S2 to S3 by an inter-socket interface. After parameter exchange of PID values, one or more of sockets S4 to S5 can communicate with one or more sockets among sockets S4 to S5 by an inter-socket interface. After parameter exchange of PID values, one or more of sockets S6 to S7 can communicate with one or more sockets among sockets S6 to S7 by an inter-socket interface.

In configuration 306, a PID value of 0 can be assigned to a socket (e.g., S0), a PID value of 1 can be assigned to another socket (e.g., S2), a PID value of 2 can be assigned to another socket (e.g., S4), a PID value of 3 can be assigned to another socket (e.g., S6), a PID value of 4 can be assigned to another socket (e.g., S1), a PID value of 5 can be assigned to another socket (e.g., S3), a PID value of 6 can be assigned to another socket (e.g., S5), and a PID value of 7 can be assigned to another socket (e.g., S7). In this example, none of sockets S0 to S7 can communicate with another of sockets S0 to S7 using an inter-socket interface, but can communicate via an out of band interface such as through a management controller.

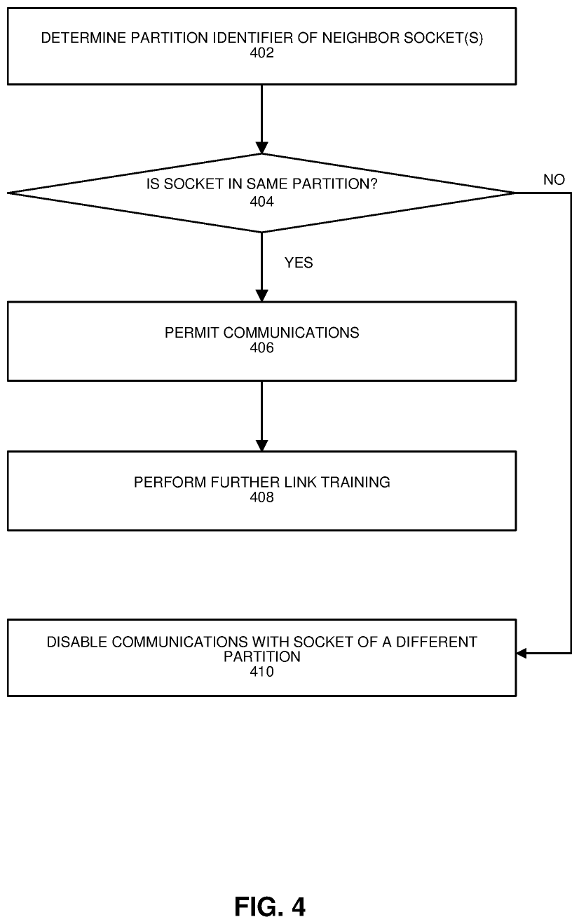

FIG. 4 depicts an example process. The process can be performed by a microcontroller-executed software during link training and/or boot firmware during or after boot. At 402, after system boot, a processor socket can determine its PID value. For example, the processor socket can utilize a microcontroller or other circuitry that reads the PID value from a power-on-configuration (POC).

At 404, during or after link training of a link with a second processor socket, the processor socket can determine if the PID values of the second processor socket and the processor socket match. For example, link training can occur at less than a highest available link speed and can include: link layer training, eye determination over a link, and parameter exchanges including providing a PID value. If the processor socket and second processor socket have a same PID value, the process can proceed to 406. At 406, communication between the processor socket and the second processor socket can be permitted to occur. For example, a PHY of the processor socket can be permitted to be powered-up to communicate with a PHY of the second processor socket. Accordingly, an OS or other software executed by the processor socket and the second processor socket can share resources (e.g., cores, cache, memory, PCIe connected devices, connected I/O, permit boot from a connected boot firmware flash device, or others) and operate with memory shared in a coherent manner. At 408, additional training on the active link can occur. For example, boot firmware code can perform additional training at higher communication speeds than performed in 404.

However, at 404, if the processor socket and the second processor socket have different PID values, the process can proceed to 410. At 410, inter-socket communication between the processor socket and the second processor socket may not be permitted. For example, a PHY of the processor socket can be disabled from communication with a PHY of the second processor socket via the inter-processor interconnect. For example, the PHY of the processor socket can be powered down.

Note the example of the process is described with respect to a second processor socket, but can also apply to additional numbers of processor sockets that are connected to the processor socket by an inter-processor interconnect.

FIG. 5 depicts a system. In some examples, processor sockets of system 500 can be configured to share resources based on being in a same partition, as described herein. System 500 includes processor 510, which provides processing, operation management, and execution of instructions for system 500. Processor 510 can include any type of microprocessor, central processing unit (CPU), graphics processing unit (GPU), XPU, processing core, or other processing hardware to provide processing for system 500, or a combination of processors. An XPU can include one or more of: a CPU, a graphics processing unit (GPU), general purpose GPU (GPGPU), and/or other processing units (e.g., accelerators or programmable or fixed function FPGAs). Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 510 can include multiple processors and multiple processors can be embodied as processor sockets.

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die. Where present, graphics interface 540 interfaces to graphics components for providing a visual display to a user of system 500. In one example, graphics interface 540 generates a display based on data stored in memory 530 or based on operations executed by processor 510 or both. In one example, graphics interface 540 generates a display based on data stored in memory 530 or based on operations executed by processor 510 or both.

Accelerators 542 can be a programmable or fixed function offload engine that can be accessed or used by a processor 510. For example, an accelerator among accelerators 542 can provide data compression (DC) capability, cryptography services such as public key encryption (PKE), cipher, hash/authentication capabilities, decryption, or other capabilities or services. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 542 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510.

Applications 534 and/or processes 536 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 532 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory. Network interface 550 can receive data from a remote device, which can include storing received data into memory. In some examples, packet processing device or network interface device 550 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 500 includes one or more input/output (I/O) interface(s) 560. I/O interface 560 can include one or more interface components through which a user interacts with system 500. Peripheral interface 570 can include any hardware interface not specifically mentioned above. Peripherals refer generally to devices that connect dependently to system 500.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 500 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 500 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Example 1 includes one or more examples and includes an apparatus that includes: a first processor socket comprising first communication circuitry, wherein the first processor socket is associated with a first partition identifier and a second processor socket comprising second communication circuitry, wherein the second processor socket is associated with a second partition identifier and wherein: based on a boot operation associated with the first processor socket: the first communication circuitry is to permit communication with the second communication circuitry based on the first partition identifier matching the second partition identifier and the first communication circuitry is to disable communication with the second communication circuitry based on the first partition identifier not matching the second partition identifier.

Example 2 includes one or more examples, wherein during link training with the second communication circuitry, the first communication circuitry is to receive the second partition identifier.

Example 3 includes one or more examples, wherein the boot operation associated with the first processor socket comprises a load of boot firmware.

Example 4 includes one or more examples, wherein the boot firmware comprises one or more of: a Basic Input/Output System (BIOS), Universal Extensible Firmware Interface (UEFI), or a boot loader.

Example 5 includes one or more examples, wherein the second processor socket is to load the boot firmware from a storage device communicatively coupled to the first processor socket.

Example 6 includes one or more examples, and includes circuitry to store the first partition identifier, wherein the circuitry to store the first partition identifier comprises one or more of: a bitmap, a pin, a fuse, or a register.

Example 7 includes one or more examples, and includes at least one non-transitory computer-readable medium comprising instructions stored thereon, that if executed by one or more processors, cause the one or more processors to: in response to a boot operation: based on a first partition identifier associated with a first processor socket matching a second partition identifier associated with a second processor socket, enable the first processor socket to communicate with the second processor socket via a socket interconnect link.

Example 8 includes one or more examples, and includes instructions stored thereon, that if executed by one or more processors, cause the one or more processors to: based on the first partition identifier associated with the first processor socket not matching the second partition identifier associated with the second processor socket, disallow the first processor socket to communicate with the second processor socket via the socket interconnect link.

Example 9 includes one or more examples, wherein the boot operation comprises loading boot firmware and wherein the boot firmware comprises one or more of: a Basic Input/Output System (BIOS), Universal Extensible Firmware Interface (UEFI), or a boot loader.

Example 10 includes one or more examples, wherein: based on the first processor socket being enabled to communicate with the second processor socket via the socket interconnect link: the first processor socket is to perform a boot operation via the second processor socket by loading boot firmware from a storage device communicatively coupled to the second processor socket.

Example 11 includes one or more examples, wherein the socket interconnect link is consistent with one or more of: Advanced Micro Devices, Inc. (AMD) Infinity Fabric, AMD HyperTransport, NVIDIA® NVLink, Advanced Microcontroller Bus Architecture (AMBA), or Intel® Ultra Path Interconnect (UPI).

Example 12 includes one or more examples, wherein: the first processor socket is to receive the second partition identifier during training of the socket interconnect link.

Example 13 includes one or more examples, wherein: the first partition identifier is stored in one or more of: a fuse, register, pin, or bitmap and the second partition identifier is stored in one or more of: a fuse, register, pin, or bitmap.

Example 14 includes one or more examples, and includes instructions stored thereon, that if executed by one or more processors, cause the one or more processors to: based on the first partition identifier associated with the first processor socket matching the second partition identifier associated with the second processor socket, perform link training of the socket interconnect link for communication between the first processor socket and the second processor socket.

Example 15 includes one or more examples, and includes a method that includes: in response to a boot operation: based on a first socket partition identifier associated with a first processor socket matching a second socket partition identifier associated with a second processor socket, enabling the first processor socket to communicate with the second processor socket via a socket interconnect link and based on the first socket partition identifier associated with the first processor socket not matching the second socket partition identifier associated with the second processor socket, disallowing the first processor socket to communicate with the second processor socket via the socket interconnect link.

Example 16 includes one or more examples, wherein the boot operation comprises loading boot firmware and wherein the boot firmware comprises one or more of: a Basic Input/Output System (BIOS), Universal Extensible Firmware Interface (UEFI), or a boot loader.

Example 17 includes one or more examples, wherein: based on the first processor socket being enabled to communicate with the second processor socket via the socket interconnect link: the first processor socket performing a boot operation via the second processor socket by loading boot firmware from a storage device communicatively coupled to the second processor socket.

Example 18 includes one or more examples, wherein the socket interconnect link is consistent with one or more of: Advanced Micro Devices, Inc. (AMD) Infinity Fabric, AMD HyperTransport, NVIDIA® NVLink, or Intel® Ultra Path Interconnect (UPI).

Example 19 includes one or more examples, and includes the second processor socket receiving the first partition identifier during training of the interconnect link.

Example 20 includes one or more examples, and includes based on the first partition identifier associated with the first processor socket matching the second partition identifier associated with the second processor socket, performing link training of the socket interconnect link for communication between the first processor socket and the second processor socket.

1. An apparatus comprising:
a first processor socket comprising first communication circuitry, wherein the first processor socket is associated with a first partition identifier and
a second processor socket comprising second communication circuitry, wherein the second processor socket is associated with a second partition identifier and wherein:
based on a boot operation associated with the first processor socket:
the first communication circuitry is to permit communication with the second communication circuitry based on the first partition identifier matching the second partition identifier and
the first communication circuitry is to disable communication with the second communication circuitry based on the first partition identifier not matching the second partition identifier.

2. The apparatus of claim 1, wherein:
during link training with the second communication circuitry, the first communication circuitry is to receive the second partition identifier.

3. The apparatus of claim 1, wherein the boot operation associated with the first processor socket comprises a load of boot firmware.

4. The apparatus of claim 3, wherein the boot firmware comprises one or more of: a Basic Input/Output System (BIOS), Universal Extensible Firmware Interface (UEFI), or a boot loader.

5. The apparatus of claim 3, wherein the second processor socket is to load the boot firmware from a storage device communicatively coupled to the first processor socket.

6. The apparatus of claim 1, comprising circuitry to store the first partition identifier, wherein the circuitry to store the first partition identifier comprises one or more of: a bitmap, a pin, a fuse, or a register.

7. At least one non-transitory computer-readable medium comprising instructions stored thereon, that if executed by one or more processors, cause the one or more processors to:
in response to a boot operation:
based on a first partition identifier associated with a first processor socket matching a second partition identifier associated with a second processor socket, enable the first processor socket to communicate with the second processor socket via a socket interconnect link.

8. The at least one non-transitory computer-readable medium of claim 7, comprising instructions stored thereon, that if executed by one or more processors, cause the one or more processors to:
based on the first partition identifier associated with the first processor socket not matching the second partition identifier associated with the second processor socket, disallow the first processor socket to communicate with the second processor socket via the socket interconnect link.

9. The at least one non-transitory computer-readable medium of claim 7, wherein the boot operation comprises loading boot firmware and wherein the boot firmware comprises one or more of: a Basic Input/Output System (BIOS), Universal Extensible Firmware Interface (UEFI), or a boot loader.

10. The at least one non-transitory computer-readable medium of claim 7, wherein:
based on the first processor socket being enabled to communicate with the second processor socket via the socket interconnect link:
the first processor socket is to perform a boot operation via the second processor socket by loading boot firmware from a storage device communicatively coupled to the second processor socket.

11. The at least one non-transitory computer-readable medium of claim 7, wherein the socket interconnect link is consistent with one or more of: Advanced Micro Devices, Inc. (AMD) Infinity Fabric, AMD HyperTransport, NVIDIA® NVLink, Advanced Microcontroller Bus Architecture (AMBA), or Intel® Ultra Path Interconnect (UPI).

12. The at least one non-transitory computer-readable medium of claim 7, wherein:
the first processor socket is to receive the second partition identifier during training of the socket interconnect link.

13. The at least one non-transitory computer-readable medium of claim 7, wherein:
the first partition identifier is stored in one or more of: a fuse, register, pin, or bitmap and
the second partition identifier is stored in one or more of: a fuse, register, pin, or bitmap.

14. The at least one non-transitory computer-readable medium of claim 7, comprising instructions stored thereon, that if executed by one or more processors, cause the one or more processors to:
based on the first partition identifier associated with the first processor socket matching the second partition identifier associated with the second processor socket, perform link training of the socket interconnect link for communication between the first processor socket and the second processor socket.

15. A method comprising:
in response to a boot operation:
based on a first socket partition identifier associated with a first processor socket matching a second socket partition identifier associated with a second processor socket, enabling the first processor socket to communicate with the second processor socket via a socket interconnect link and
based on the first socket partition identifier associated with the first processor socket not matching the second socket partition identifier associated with the second processor socket, disallowing the first processor socket to communicate with the second processor socket via the socket interconnect link.

16. The method of claim 15, wherein the boot operation comprises loading boot firmware and wherein the boot firmware comprises one or more of: a Basic Input/Output System (BIOS), Universal Extensible Firmware Interface (UEFI), or a boot loader.

17. The method of claim 15, wherein:
based on the first processor socket being enabled to communicate with the second processor socket via the socket interconnect link:
the first processor socket performing a boot operation via the second processor socket by loading boot firmware from a storage device communicatively coupled to the second processor socket.

18. The method of claim 15, wherein the socket interconnect link is consistent with one or more of: Advanced Micro Devices, Inc. (AMD) Infinity Fabric, AMD HyperTransport, NVIDIA® NVLink, Advanced Microcontroller Bus Architecture (AMBA), or Intel® Ultra Path Interconnect (UPI).

19. The method of claim 15, comprising:
the second processor socket receiving the first partition identifier during training of the interconnect link.

20. The method of claim 15, comprising:
based on the first partition identifier associated with the first processor socket matching the second partition identifier associated with the second processor socket, performing link training of the socket interconnect link for communication between the first processor socket and the second processor socket.
